(19) United States
(12) Patent Application Publication
(10) Pub. No.: US 2016/0047138 A1
(43) Pub. Date: Feb. 18, 2016

(54) MOUNT FOR DECORATIVE ELEMENT

(71) Applicants: Larry G. McCaslin, Clear Lake Shores, TX (US); Mark A. McCaslin, League City, TX (US)

(72) Inventors: Larry G. McCaslin, Clear Lake Shores, TX (US); Mark A. McCaslin, League City, TX (US)

(21) Appl. No.: 14/462,517

(22) Filed: Aug. 18, 2014

(51) Int. Cl. E04H 13/00; F21V 33/00; A47G 7/04; A01G 9/02; A47G 7/06

(52) U.S. Cl. CPC E04H 13/001; A01G 9/02; A47G 7/06; A47G 7/041; E04H 13/003; F21V 33/0028; F21W 2121/00

(57) ABSTRACT

A mount for a decorative element for a grave marker, headstone, or other structure for displaying flowers or other indicia provided by the family and/or cemetery operator. The mount is affixed to the marker by inserting a bucket into a hole in the base, mounting a ring to the bucket, and activating structure formed on the bucket to draw that structure into engagement with the undersurface of the base. Once the ring and bucket are affixed to the base, a decorative element is releasably secured to the ring. Either or both of the decorative element or ring is provided with a receptacle for receiving a flag pole, a scabbard for receiving the lance of a wreath holder, or a landing for receiving an insert marked with commemorative or display indicia.

This application claims the benefit of U.S. provisional application No. 61/866,655, filed Aug. 16, 2013. Application No. 61/866,655 is hereby incorporated into this application in its entirety by this specific reference thereto.

### BACKGROUND OF THE INVENTION

The present invention relates to a mount for a decorative element such as a vase or urn that is mounted to a grave, headstone, or other ceremonial marker or memorial. In more detail, the present invention relates to a mount for a decorative element that, in one embodiment, is as an urn or vase for mounting to a grave, headstone, or other indoor or outdoor wall, mausoleum, columbarium, memorial, historical or commemorative site, or other ceremonial marker.

A visit to any cemetery will reveal that a large number of grave markers are provided with a ceremonial urn or vase. Generally comprised of brass, bronze, or other semi-valuable material, and therefore heavy and expensive, the vase holds flowers and/or other displays provided by the family of the deceased or by the operator of the cemetery. Unfortunately, because they are comprised of bronze, these vases are often a target for thieves; for some reason, they are also a favorite target for graveyard vandals. After it is stolen or damaged, the vase must be replaced, and it is not uncommon for several vases to be stolen or damaged at the same time such that replacing the vases requires substantial resources. Replacement of a damaged vase often requires access to the underside of the base of the headstone or other marker to which it is mounted so that the vase can be removed and then reinstalled. The logistics of replacing stolen or damaged ceremonial vases are made more difficult by the relatively large and heavy nature of the vases, making them difficult to transport, handle, and store. Because of the storage and handling, as well as the expense, it is problematical for the cemetery operator to keep a supply of replacement vases on hand and it is therefore an object of the present invention to provide a replacement vase that is light and relatively expensive, but that also provides the impression of permanence and ceremony that is appropriate for use in a cemetery.

Another problem that must be addressed is the actual replacement of the vase or other decorative element that is mounted to or on a grave marker because the mount, and sometimes even the grave marker itself, may be damaged when the vase or decorative element is vandalized or stolen. It is therefore also an object of the present invention to provide a mount for a decorative element for a grave marker or other memorial that enables the decorative element to be quickly and conveniently replaced and that has a construction and is made of materials that cause the decorative element to break before the grave marker, headstone, or other memorial is damaged, thereby avoiding an expensive and time-consuming repair to the grave marker, headstone, or memorial.

Another object of the present invention is to provide a mount for a decorative element such as a vase that is constructed in a manner that the decorative element can be made of such materials as to enable a cemetery operator to keep a substantial number of replacements on hand for use when several decorative elements in the cemetery have been stolen or vandalized.

Another object of the present invention is to provide a mount for a decorative element such as a vase or urn for a grave marker or other memorial that is provided with structure that enables the decorative element to hold a display other than flowers, including wreath holders, anchors for lighter-than-air balloons and mounts for flags, banners (for instance, a family crest), religious indicia, and other displays or memorabilia of the deceased, a function not previously known in the industry or, if known, not in widespread use. On information and belief, such items are not known and/or little used in the industry for reasons relating to the difficulties of securing and/or mounting such items to markers and memorials that are currently in use, and the present invention addresses that problem.

It is also an object of the present invention to provide a decorative element for a marker or other memorial in the form of a vase having a shape, or configuration, for better retaining flowers in the vase and if utilized for fresh cut flowers or live plants or flowers, providing a better configuration for retaining water in the vase.

Yet another object of the present invention is to provide a mount for a decorative element such as a vase for a grave marker or other memorial that enables the decorative element to be mounted on a base that is not horizontal, at angles other than vertical, and/or that enables the decorative element to be mounted vertically even when the surface to which it is mounted is not vertical.

Other objects, and the many advantages of the present invention, will be made clear to those skilled in the art in the following detailed description of the preferred embodiment(s) of the invention and the drawing(s) appended hereto. Those skilled in the art will recognize, however, that the embodiment(s) of the present invention described herein are only examples of specific embodiment(s), set out for the purpose of describing the making and using of the present invention, and that the embodiment(s) shown and/or described herein are not the only embodiment(s) of method performed in accordance with the teachings of the present invention.

### SUMMARY OF THE INVENTION

The present invention meets the above-described objects by providing a mount for a decorative element comprising a bucket adapted for positioning either under a base or in a hole through a base and having a portion extending through the hole to the underside of the base and a ring located above the base so that the decorative element can be replaced without having to move or replace the base. Both the bucket and the ring are provided with structure for engaging the base for use in mounting the decorative element to the base without the need to remove the base or even to access the underside of the base. Also provided is means for either selectively advancing the bucket toward the ring or for advancing the ring toward the bucket for causing either or both of the structure formed on the bucket or the structure formed on the ring to engage the base for releasably mounting the bucket and ring to the base. Means is formed on the ring for engaging the decorative element when the ring is engaged to the base and, in a particularly preferred embodiment, the decorative element engaging means also serves to provide storage for the decorative element.

### BRIEF DESCRIPTION OF THE DRAWINGS

FIG. 1 is an exploded, perspective view of a first embodiment of a mount for a decorative element constructed in accordance with the teachings of the present invention that is adapted for engaging a ceremonial urn.

FIG. 2 is a perspective view of the mount for a decorative element of FIG. 1.

An elevational view of the embodiment of the mount for a decorative element shown in FIG. 1 as mounted to a base such as a headstone or other relatively flat slab of concrete or rock such as a grave marker is shown in FIG. 3.

FIG. 4 shows a sectional view of the mount for a decorative element for a grave marker shown in FIG. 1 as mounted to a base and taken along the lines A-A in FIG. 3, but showing not only the internal details of the manner in which a decorative element such as a vase or ceremonial urn is engaged by the mount of the present invention but also the manner in which the vase or urn is stored inside the mount.

### DETAILED DESCRIPTION OF THE PREFERRED EMBODIMENT(S)

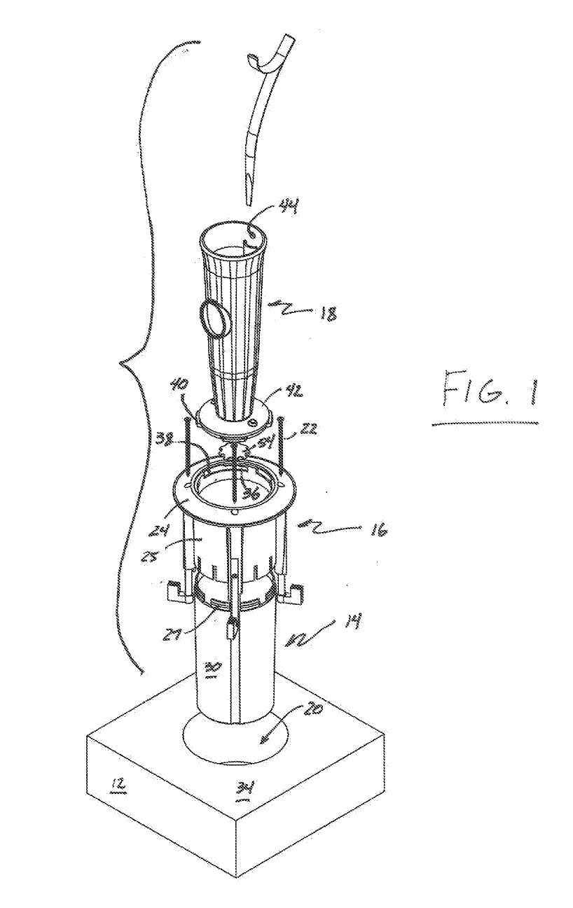

Referring to the figures, one embodiment of a mount for a decorative element for a grave marker that is constructed in accordance with the present invention is indicated generally at reference numeral 10. The particular embodiment shown is intended to be affixed to a base that may take the form of a horizontal grave marker, headstone, memorial, or other element, a portion of which is shown at reference numeral 12 in FIGS. 1, 3, and 4, but as described in more detail below, those skilled in the art will recognize from this disclosure that the mount of the present invention also enables the mounting of a decorative element to bases that are not horizontal. Those skilled in the art will also recognize from this description that the surface to which the mount of the present invention is affixed need not be a grave marker or headstone, hence the use of terms such as “base” and “structural element” in this specification to describe the structure to which the mount for a decorative element of the present invention is affixed. By way of example (and not limitation), the base or structural element to which the mount of the present invention is affixed may be the wall of a building or other structure such as a mausoleum, memorial, pedestal, obelisk, shrine, columbarium, a decorative or structural wall or column, structure such as an alcove set into a wall or column, or even a historical or commemorative marker.

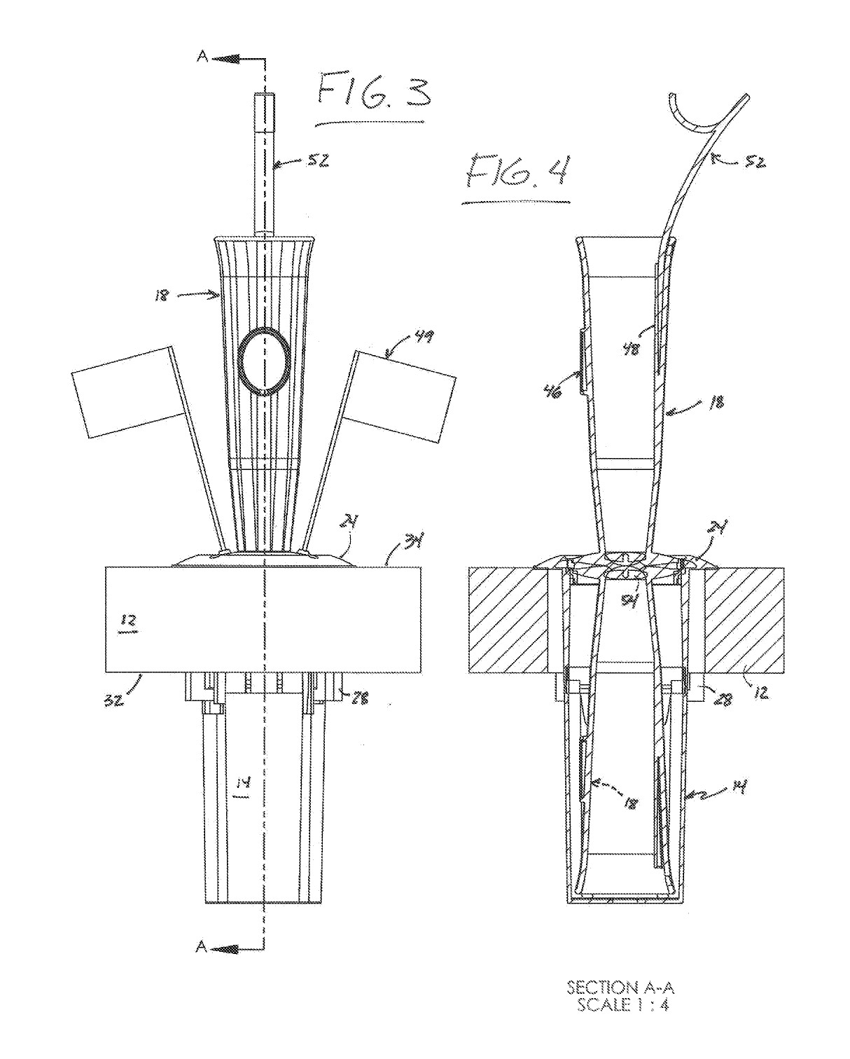

The particular embodiment of the mount 10 shown in the figures is comprised of three main parts, a bucket 14, ring 16, and means 19 (described below) for engaging a decorative element; in the embodiment shown, the decorative element is a ceremonial vase as shown at reference numeral 18. In the embodiment shown, ring 16 is comprised of a flange 24 and tube 25, tube 25 being formed in the shape of a right cylinder. Bucket 14 is likewise formed in the shape of a right cylinder and bucket 14 and the tube 25 of ring 16 are assembled to one another on snap grooves 27 for insertion into a cylindrical bore 20 (see FIGS. 3 and 4) through base 12. In the embodiment shown, the assembled ring 16 and bucket 14 are inserted into bore 20 far enough for bucket 14 to be positioned below base 12, but those skilled in the art will recognize from this disclosure that the bucket 14 may be constructed in an embodiment (not shown) in which bucket 14 is provided with structure that enables the bucket 14 to be positioned in bore 20 (rather than being inserted all the way through bore 20 such that bucket 14 is positioned below base 12 with a portion of the bucket 14 extending below base 12). By way of example, either of bucket 14 or ring 16 may be constructed in such a manner as to expand radially outwardly into frictional engagement with the surface comprising the inside diameter (I.D.) of base 12, and specifically, because the decorative element 10, or the bucket and ring 14, 16, is constructed of a polymeric material as described below, which may be a resilient polymeric material, the tubular portion of bucket 14 or the tube 25 of ring 16 may be compressed for insertion into the bore 20 in base 12. Alternatively, one or the other of ring 16 or bucket 14 is formed of a material that is less resilient than the other and their respective diameters sized so that when they are rotated relative to each other, one or the other of bucket 14 or ring 16 causes the other component to expand radially outwardly into engagement with the I.D. of bore 20. However, because the bore 20 may be of different diameters from one base to another, and because radially outward expansion of either of bucket 14 or ring 16 is limited, it is generally preferred to utilize the embodiment shown in FIGS. 1-4, in which the feet 28 of mounting locks 26 are rotated outwardly relative to the outside surfaces of bucket 14 and ring 16 upon the tightening of the screws 22, all as described in more detail below. An embodiment in which the bucket 14 or ring 16 expands radially outwardly is of particular use in applications in the diameter of the bore 20 is controlled such that there is limited space between the outside surfaces of bucket 14 or base 16 and the I.D. of bore 20, in applications in which the bottom, or under surface 32 of base 12 is particularly uneven such that the feet 28 may not securely engage that surface, and in applications in which the material comprising base 12 is friable, fragile, or does not provide good purchase of the feet 28 on base 12. Those skilled in the art will recognize that threads, particularly quick-connect, or quarter-turn, threads may be utilized in place of the snap grooves 27 for quickly and conveniently assembling the bucket 14 and ring 16 to each other for placement in the bore 20 in base 12.

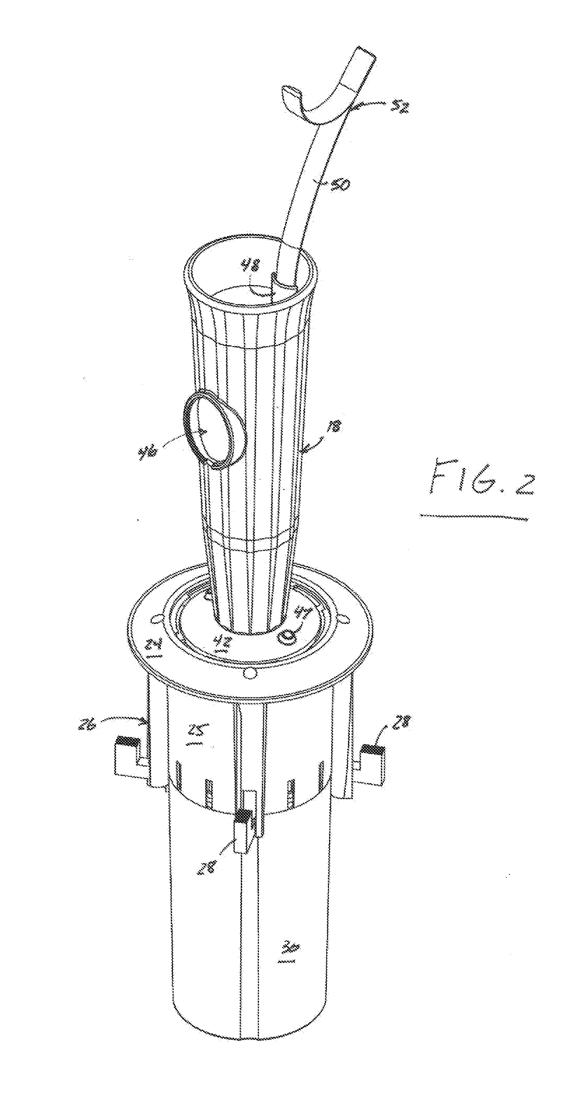

Upon assembly and rotation of the screws 22 into the holes (not numbered) in ring 16, the tips of screws 22 engage the mounting locks 26 to cause the feet 28 of locks 26 to rotate radially outwardly from the outside surface 30 of bucket 14 and then to be drawn upwardly into contact with the undersurface 32 of base 12. As a result of the engagement of the undersurface 32 (shown in FIGS. 2 and 3) of base 12 by the outwardly extending feet 28, all or a portion of the material comprising base 12 is “sandwiched” between the feet 28 and the flange 24 formed integrally on ring 16, ring 16 engaging the top surface 34 of base 12, to affix the assembled bucket 14 and ring 16 to base 12. Because the embodiment shown in the figures is intended for use on headstones, grave markers, and the like, which usually have a smooth top surface, the flange 24 of ring 16 may be formed of a material that is relatively hard while still providing an esthetically pleasing interaction with that smooth surface 34, but of course the underside 32 of the base 12 may not be at all smooth and so the feet 28 of mounting locks 26, which need not be esthetically pleasing, provide positive engagement with that potentially uneven surface 32. It will be recognized by those skilled in the art that the flange 24 of ring 16 may also be provided with a gasket or seal to insure a close fit to the upper surface of base 12 and that the gasket or seal may even be comprised of a resilient material to provide a close fit with an uneven upper surface of a base 12.

The means 19 for engaging the decorative element (in the embodiment shown, the decorative element is the vase or urn 18) takes the form of a screw thread 36 having gaps 38 formed on the inside surface (the inside diameter) of ring 16 for receiving complimentary-shaped tabs, or ears, 40 (best shown in FIG. 1) formed on the periphery of the base plate 42 of decorative vase 18. Upon insertion of the ears 40 through gaps 38 and rotation of the decorative vase 18 relative to ring 16 on thread 36, the vase 18 is secured to ring 16. Further, the structure of ring 16 and the base plate 42 of vase 18 is such that decorative vase 18 is capable of being secured to ring 16 after ring 16 has been secured to the base 12. In this manner, the mount 10 of the present invention functions to releasably, or demountably secure decorative vase 18 to the base 12 of the marker or other structural element.

In another preferred embodiment (not shown in the figures), the decorative element engaging means 19 is provided with a swivel or hinge between the bowl and the base plate 42 of the vase 18 for mounting vase 18 to the surface of a base 12 that is not horizontal. Suitable swivels and hinges for this purpose are known in the art; in one embodiment, the swivel is provided with a set screw so that once the bowl of a decorative element such as vase 18 is positioned relative to base 12, the screw can be tightened to retain the vase 18 in that position.

As noted above, vases commonly found in cemeteries are comprised of bronze, but those skilled in the art will recognize from this disclosure that the decorative element of the present invention is comprised of a material, such as a polymeric material, that is molded to form the structure described herein. As will also be clear from this description, the weight of the decorative element, being comprised of polymeric material, is substantially less than the weight of a bronze vase, and as a consequence of the use of such polymeric materials, the cost of the decorative element is also substantially reduced.

The molded material from which the decorative element of the present invention is formed is preferably provided with a finish that either resembles the hammered finish characteristic of existing bronze vases or with a coating that is applied to the molded polymeric material that either resembles the hammered bronze finish or provides some other esthetically pleasing appearance. As will be clear from this description, however, the use of a polymeric material enables, for the first time so far as is known, the opportunity to mold a vase, urn, or other decorative element 18 in colors. For instance, on information and belief, many proud graduates of the public universities in the Great State of Texas would choose to be buried in a grave highlighted by a vase in Aggie maroon; some poor lost souls might even choose a burnt orange vase. Note also that the location of the flange 24 of base ring 16 at a point that is visible creates the opportunity for the use of a second color such that a Texas Tech graduate could choose to have his/her grave or memorial marked with both of the red and black colors that are so prominent on the campus in Lubbock, Tex., a Paul Quinn College graduate could choose a grave marker accented with purple and gold, and a Dallas Cowboy fan could choose a grave marker accented with blue and silver.

Further, because the vase of the present invention is molded from a polymeric material, it is possible to provide the decorative element of the present invention with structure that simply is not available in a bronze vase simply by molding such structure into the decorative element. For instance, and referring to FIG. 1, the vase 18 that comprises one embodiment of the decorative element of the present invention may be provided with one or more holes 44, located on either the decorative vase 18 or the base ring 16, to which the string of a lighter-than-air balloon (not shown) may be tethered.

Similarly, one or more landings, or flats, 46 to which display indicia may be attached may be molded into the outside surface of vase 18. In one embodiment (not shown), the flats are molded in, for instance, a round shape and are provided with a peripheral ridge having a screw thread molded therein so that an insert (not shown) having a symbol or insignia applied thereto, can be screwed into the landing 46. Alternatively, the landing 46 is oval-shaped, square, or rectangular and provided with slots or a peripheral ridge having a resilient groove or snap ring formed therein and a complimentary-shaped oval insert (also not shown) is snapped into the landing 46 either by inserting tabs into slots or by compressing the peripheral ridge. Other structure that enables the insert to be assembled to landing 46 is known to those skilled in the art.

Receptacles 47 for receiving the post or pole to which the flag post of the flags 49 (shown only in FIG. 3) may be mounted are provided in ring 16 in the embodiment shown, but similar receptacles may also be formed on the outside surface, or the top rim, of decorative vase 18. Similarly, the inside surface of the bowl of vase 18 may be provided with a scabbard 48 for receiving the lance 50 of a wreath holder 52. It will also be apparent that the scabbard of a wreath holder may be formed on the outside surface of vase 18, that a wreath holder may be mounted in a slot formed in ring 16, and/or that the receptacles 47 that are described above for receiving flags may be formed on the bowl of vase 18, and so on, all in accordance with esthetic considerations and all facilitated by the molding of the present invention from polymeric material(s). Similarly, the wreath holder may be mounted to either the decorative vase 18 or ring 16 using other types of structure known in the art; by way of example, either the inside or outside surface of vase 18 may be provided with two or more mushroom-head posts (not shown) that are received within complimentary-shaped holes (also not shown) formed in the wreath holder, the resilience of the polymeric material from which the vase 18 is molded providing the opportunity for compression of the heads of the posts as the wreath holder is snapped onto the posts and the retention of the wreath holder to decorative vase 18. It will also be recognized that rather than the receptacles 47, a flag may be mounted to the vase of the present invention utilizing structure similar to the scabbard 48 described above for mounting a wreath to the vase, the shape of the scabbard being configured to receive a flag pole rather than the flat-shaped lance 50.

The use of a material that can be molded also creates the opportunity for such structure as molding the bowl of the decorative vase 18, particularly the inside surface of the bowl, to better retain flowers placed in the vase and also to minimize the surface area of the water placed in the bottom of the vase to keep the flowers fresh, thereby reducing evaporation and increasing the life of the flowers. The decorative vase 18 can also be molded in a shape that enables a live plant to be planted in the vase, the shape of the vase 18 being configured to retain the dirt and water therein so that the plant enjoys a long life.

As noted above, one of the objects of the present invention is for the operator of a cemetery to be able to reduce the amount of space required to keep replacement urns/vases in stock for immediately replacing damaged or stolen vases. Of course the substantial reduction in the weight of the present invention helps the present invention achieve that goal, but in a preferred embodiment, the present invention is provided with structure that further addresses that object. Referring in particular to FIG. 1, it can be seen that the bottom of the base plate 42 of decorative vase 18 is provided with a knob 54. The diameter of decorative vase 18 is sized so that, as shown in Fig when decorative vase 18 is inverted, the entire vase 18 fits down into the bucket 14 and ring 16 for ease of transportation and storage, and to protect the finish applied to vase 18. When it is desired to assemble the vase 18 to a base, the vase 18 is easily withdrawn from bucket 14 and ring 16 by grasping the knob 54 and lifting the vase 18 out of the bucket 14 and ring 16.

Those skilled in the art who have the benefit of this disclosure will recognize that changes can be made to the component parts of the present invention without changing the manner in which those component parts function and/or interact to achieve their intended result. For example, although described herein as a decorative vase or urn that is mounted to a grave marker or other base, those skilled in the art will recognize that a statute or figurine may be substituted for the decorative vase 18 shown herein. Similarly, a torch of the type referred to as an eternal flame may be substituted for decorative vase 18, the bucket 14 providing a location for the reservoir of flammable material required for such a flame. In another embodiment, a light or other source of illumination is mounted to the base 12 in place of, or in addition to, the decorative vase 18, the base bucket 14 providing a location for the battery or power source for the source of illumination. In one alternative embodiment, the source of illumination takes the form of one or more light emitting diodes positioned behind the display indicia mounted to the flats 46 for illuminating the display indicia. Alternatively, the light source is located within the bucket 14 or ring 16 and a lens or other structure for directing or diffracting the light is mounted between ring 16 and decorative vase 18 to provide a desired lighting effect. In another alternative embodiment, the decorative vase 18 is provided with one or more translucent or transparent inserts, or windows, that snap into complimentary-shaped openings (not shown) formed in the wall of vase 18 and an LED or other light source located inside the vase 18 shines through the insert. In one particular such embodiment, the inserts are formed in the shapes of letters to, for instance, provide the initials of the deceased or an acronym signifying the deceased's branch of military service, faith, or other significant aspect or attribute of the deceased. The letters formed by such inserts may also spell out one or more words for using the decorative element 10 of the present invention for a directional or informative sign when the decorative element 10 is utilized for a structure, such as commemorative memorial, other than a grave marker, columbarium or crematorium. Another example of a change that does not change the manner in which the component parts function to achieve their intended result is the tabs 40 formed on the base plate 42 of decorative vase 18 and threads 36 formed on ring 16. Many other arrangements of tabs, screw threads, stops, catches, latches, quick-lock and/or quarter turn connectors, and similar structure are known in the art and all function interchangeably for the purpose of securing the decorative vase 18 to the assembled ring 16 and bucket 14 after the bucket 14 and ring 16 have been secured to base 12. All such changes, and others that will be clear to those skilled in the art from this description of several embodiment(s) of the invention, are intended to fall within the scope of the following, non-limiting claims.

What is claimed is:

1. A mount for a decorative element comprising:
a bucket located either under a base or positioned in a hole through the base and having a portion extending through the hole to the underside of the base, said bucket having structure formed thereon for engaging the underside of the base;
a ring located above the base and having structure formed thereon for engaging the base;
means for either selectively advancing said bucket toward said ring or for advancing said ring toward said bucket for causing either or both of the structure formed on said bucket or the structure formed on said ring to engage the base; and
means formed on said ring for engaging a decorative element when said ring is affixed to the base.

2. The mount of claim 1 wherein said bucket and said ring both include cylindrical portions, the cylindrical portions of said bucket and said ring fitting through the bore in the base.

3. The mount of claim 2 wherein the base engaging structure formed on said bucket is selectively positionable in a first position in which the base is not engaged and a second position in which the base is engaged.

4. The mount of claim 1 wherein the base engaging structure formed on said bucket comprises a plurality of mounting locks having feet formed thereon, each said mounting lock being selectively positionable in a first position in which the feet of said mounting locks do not engage the base and a second position in which the feet of said mounting lock engage the base.

5. The mount of claim 1 additionally comprising either a hinge or a swivel for positioning said decorative element at an angle relative to the base other than perpendicular.

6. The mount of claim 1 wherein said decorative vase is releasably engaged to the base.

7. The mount of claim 1 wherein said base engaging means comprises a flange.

8. The mount of claim 1 additionally comprising a flag holder located on either said decorative vase or said base or on both said decorative vase and said base.

9. The mount of claim 1 additionally comprising a scabbard either formed on either said decorative vase or on said base for receiving a wreath holder.

10. The mount of claim 1 wherein said decorative vase is provided with one or more display indicia.

11. The mount of claim 10 additionally comprising a light source located in said decorative vase and a power source for said light located in said base bucket.

12. The mount of claim 1 additionally comprising a light source located in said decorative vase and a power source for said light located in said base bucket.

13. A decorative vase comprising:
means formed on said vase for releasably mounting said vase to a base;
one or more inserts for releasably mounting to said vase; and
one or more landings formed on said vase for receiving a respective insert, each of said landings being provided with means for retaining the respective insert thereto.

14. A decorative element for a grave marker or memorial, the grave marker or memorial including a base, comprising:
a ring for mounting to the base of the grave marker or memorial;
a decorative element for releasably mounting to said ring when said ring is mounted to the base of the grave marker or memorial; and
one or more receptacles located on either or both of said decorative element or said ring, each of said receptacles being configured for receiving a flag pole therein.
